(19) United States
(12) Patent Application Publication
(10) Pub. No.: US 2022/0248692 A1
(43) Pub. Date: Aug. 11, 2022

(54) Recurring Action Tool/Machine Tool for the production of a laminated dough product

(71) Applicant: Abdurrahman Atique Khalidi, Laurel, MD (US)

(72) Inventor: Abdurrahman Atique Khalidi, Laurel, MD (US)

(21) Appl. No.: 17/157,705

(22) Filed: Feb. 10, 2021

(51) Int. Cl. A21C 9/06; A23P 20/20

(52) U.S. Cl. CPC A21C 9/066; A23P 20/20

(57) ABSTRACT

A unit tool, Shapes, cuts and seals two or more layers of dough to make a food product. As a unit is function ready and easy if used as a hand-held tool. Supports larger production When used as units in a cluster arrangement in a machine format. Scale of production can be Controlled by number of unit molds used.

Function ready tool that shapes, seals and cuts two or more layers of Dough into a perfect food product on one execution

### SPECIFICATION DESCRIPTION OF RECURRING ACTION TOOL

A. SHAPE A square 9.5 cm×905 cm

SIZE Outer wall 1.5 cm high and 9.5 cm side

Material Made out of 100% stainless steel.

B. A stainless-steel square pyramid. 1.5 greatest interior height. A rectangular handle when used

As a hand-held tool.

C. An inner metal lining that is attached to the (inside) inner walls of the pyramid square.

Makes a complete perfect pattern.

D. Cooperative Patent Classification Codes

A21C A23P B25D

### HOW, IN WHAT WAY OR MANNER THE TOOL WORKS

Mechanism of Action

1. Shape is formed by impact of confined space

2. Cut is performed by using the bottom metal

Border walls.

3. Sealing of two or more Dough layers is performed

By the metal lining ⅛ inch above the cutting base line

### METHOD OR PROCEDURE TO USE THE TOOL

1. Obtain a cut of 4 inches×4 inches square Filo Dough sheet.

2. Put a desired filling about 25 to 30 grams into the middle of the dough sheet.

3. Cover with a second dough sheet exactly matching on top of filling.

4. Use the tool on top of assembly to shape, seal the dough layers and cut to obtain the product in one execution.

1. Function ready tool that shapes the dough layers containing the filling into a rectangular pyramid by virtue of confined space

2. The 2 layers of dough are sealed by the impact of the inner metal lining

3. The metal permitter wall of the square pyramid cuts the dough layers All three claims are performed in one execution of tool action.
